(19) United States
(12) Patent Application Publication
(10) Pub. No.: US 2008/0145554 A1
(43) Pub. Date: Jun. 19, 2008

(54) THERMAL SPRAY POWDERS FOR WEAR-RESISTANT COATINGS, AND RELATED METHODS

(75) Inventors: Farshad Ghasripoor, Scotia, NY (US); Todd Charles Curtis, Schenectady, NY (US); Dennis Michael Gray, Delanson, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC, Schenectady, NY (US)

(21) Appl. No.: 11/610,857

(22) Filed: Dec. 14, 2006

(51) Int. Cl. B05D 1/10; C10M 125/02; C10M 125/04; C10M 125/08; C10M 125/18; C10M 125/20; C10M 125/00; C10M 129/24; C10M 129/04

(52) U.S. Cl. 427/450; 508/110; 508/165; 508/154; 508/171; 508/172; 508/155; 508/113; 508/150; 508/167; 508/577; 508/583; 427/446; 427/455

(57) ABSTRACT

A method of making a thermal spray powder is provided. The method comprises: providing a powder comprising a plurality of porous particles; infiltrating a mixture comprising a solvent and a plurality of solid lubricant particles into the porous particles; and heating the powder to a temperature sufficient to evaporate the solvent. The method of forming a wear-resistant coating is provided. The method comprises: providing a thermal spray powder; heating the thermal spray powder; and accelerating the thermal spray powder from a thermal spray gun onto the substrate, to form a deposit. Yet another embodiment provides a wear resistant coating. The wear resistant coating is formed by thermally spraying the thermal spray powder.

### BACKGROUND

The invention relates generally to thermal spray powders. More specifically, the invention relates to thermal spray powders comprising solid lubricants, and to methods of forming thermal spray powders and coatings.

Wear-resistant coatings are used extensively in many applications where sliding or fretting wear with limited or no amount of lubricant is present. These applications include cutting tools, automotive parts, and turbine parts. Wear-resistant coatings including solid lubricants dispersed in a suitable matrix have proven to be efficient under a variety of operational conditions, including high temperatures, low humidity, and so forth. However, obtaining a wear-resistant coating with a substantially uniform dispersion of solid lubricants, and with high “loading” i.e. high solid lubricant content, has proven to be challenging. In spite of much effort, there is a need for wear-resistant coatings with high solid lubricant loading and uniform dispersion, and simpler and versatile methods to prepare such coatings.

### SUMMARY OF THE INVENTION

The present invention meets these and other needs by providing a wear-resistant coating with substantially high solid lubricant loading and uniform solid lubricant dispersion. Accordingly, one embodiment of the invention is a method of making a thermal spray powder. The method comprises: providing a powder comprising a plurality of porous particles; infiltrating a mixture comprising a solvent and a plurality of solid lubricant particles into the porous particles, and heating the powder to a temperature sufficient to evaporate the solvent.

Another embodiment of the invention is a method of forming a wear-resistant coating on a substrate. The method comprises: providing a thermal spray powder; heating the thermal spray powder; and accelerating the thermal spray powder from a thermal spray gun onto the substrate, to form a deposit. The thermal spray powder is formed by the process of: providing a powder comprising a plurality of porous particles; infiltrating a mixture comprising a solvent and a plurality of solid lubricant particles into the porous particles, and heat- treating the powder to a temperature sufficient to evaporate the solvent.

Yet another embodiment provides a wear resistant coating. The wear resistant coating is formed by thermally spraying a thermal spray powder. The thermal spray powder is formed by the process of: providing a powder comprising a plurality of porous particles; infiltrating a mixture comprising a solvent and a plurality of solid lubricant particles into the porous particles, and heat- treating the powder to a temperature sufficient to evaporate the solvent.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a flow chart of a process according to one embodiment of the invention; and

FIG. 2 depicts wear resistance data for WC-CoCr coatings, with and without boron nitride particles.

### DETAILED DESCRIPTION

In the following description, like reference characters designate like or corresponding parts throughout the several views shown in the figures. It is also understood that terms such as “top,” “bottom,” “outward,” “inward,” “first,” “second,” and the like are words of convenience and are not to be construed as limiting terms. Furthermore, whenever a particular aspect of the invention is said to comprise or consist of at least one of a number of elements of a group and combinations thereof, it is understood that the aspect may comprise or consist of any of the elements of the group, either individually or in combination with any of the other elements of that group.

Referring to the drawings in general, it will be understood that the illustrations are for the purpose of describing one embodiment of the invention, and are not intended to limit the invention thereto.

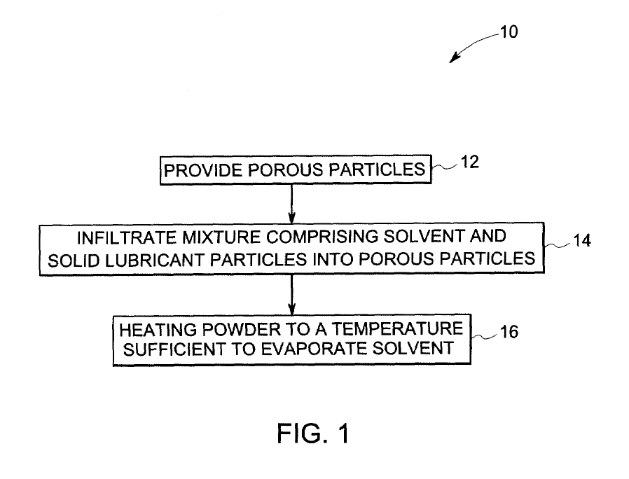

A method of making a thermal spray powder is disclosed. FIG. 1 shows a flow chart of a method 10 provided for making a thermal spray powder. The method (10) comprises the steps of: providing a powder comprising a plurality of porous particles, in step 12; infiltrating a mixture comprising a solvent and a plurality of solid lubricant particles into the porous particles, in step 14; and heating the powder to a temperature sufficient to evaporate the solvent, in step 16.

In step 12, a powder comprising a plurality of porous particles is provided. The porous particles typically comprise a matrix component, made of a suitable material. The matrix component comprises material selected from the group consisting of a metal, a metal alloy, a ceramic, a cermet, and various combinations thereof. Choice of the constituents for a particular matrix will depend on a variety of factors. One factor relates to the composition of the other constituents of the powder, for example, the type of solid lubricant employed, the type of ceramic particles used in case of cermets, and the ability of the matrix material to adequately “wet” those particles. Another factor involves performance parameters for particular end uses for the thermal spray powder, e.g., in terms of characteristics such as corrosion resistance, heat resistance, oxidation resistance, and wear resistance. Another factor relates to the potential interaction of matrix material with other constituents, e.g., the potential formation of undesirable compounds or phases at elevated temperatures.

In certain embodiments, the matrix comprises a metal or a metal alloy. The metal comprises at least one metal selected from the group consisting of titanium, nickel, iron, cobalt, chromium, aluminum, yttrium and various combinations of these. In a particular embodiment, the matrix comprises cobalt. In another particular embodiment, the matrix comprises nickel. The matrix may comprise an alloy of any of the aforementioned metals.

The metallic matrix very often includes a variety of other elements, depending on many of the factors discussed previously. Non-limiting examples are refractory elements such as tantalum, niobium, tungsten, zirconium, hafnium, and molybdenum; as well as titanium, chromium, silicon, boron, calcium, cerium, iron, and vanadium. Many combinations of these elements may also be employed, and the selection of any element or combination thereof will depend on many of the criteria noted above. As an example, niobium can be included to provide ductility and strength, while chromium, zirconium, silicon, calcium, and cerium may be added to enhance oxidation resistance. In some instances, boron and silicon are also added for melting point suppression, while chromium (mentioned above) and molybdenum are often added for corrosion resistance.

A non-limiting illustration of the amount of components in the porous particle (for some embodiments) can be provided. Thus, for certain compositions in which the matrix comprises at least about 25% by weight nickel, typical ranges for other constituents (if present) may be as follows (based on total powder composition, in weight):

Ta: about 0.5% by weight to about 1.5% by weight;

Ti: about 0.5% by weight to about 2% by weight;

Nb: about 0.5% by weight to about 2% by weight;

W: about 1% by weight to about 10% by weight;

Cr: about 2% by weight to about 10% by weight;

Zr: about 0.5% by weight to about 1% by weight;

Hf: about 0.5% by weight to about 1% by weight;

Si: about 0.5% by weight to about 4.5% by weight;

B: about 0.5% by weight to about 3.5% by weight; and

Mo: about 0.5% by weight to about 18% by weight.

In some particular embodiments, the matrix composition itself comprises nickel and chromium. For example, the matrix could include about 70% to about 90% nickel and about 5% to about 25% chromium, based on the total weight of the matrix, with the balance comprising one or more of the elements listed above. In other embodiments, the matrix composition comprises nickel, chromium and molybdenum. In that instance, the matrix may sometimes include about 50% to about 80% nickel; about 5% to about 20% chromium, and about 10% to about 30% molybdenum, with the balance comprising the other elements described previously. Those skilled in the art will be able to select the most appropriate matrix composition for a particular situation, based in part on the teachings herein. Usually, the metallic matrix (component (a)) is present at a level in the range of about 5% by volume to about 50% by volume, based on the total volume. In some specific embodiments, the metallic matrix is present at a level in the range of about 15% by volume to about 35% by volume.

In certain embodiments, the matrix comprises a ceramic. Examples of some wear resistant ceramics include, but are not limited to, aluminum oxide, chromium oxide, chromium-carbide, tantalum carbide, titanium diboride, titanium oxide, tungsten-carbide, and titanium carbide. In certain embodiments, additional materials may be added, for example silicon dioxide, to improve the mechanical properties of the ceramic material.

In certain embodiments, the matrix comprises a cermet. Cermets are a group of composite materials consisting of an intimate mixture of ceramic and metallic phases. They are typically formed by introducing hard ceramic particles into a metallic matrix. The ceramic phase, with appropriate exposure at the surface, assumes the tribological role (they are characterized by high abrasion resistance), while the metallic matrix can take the mechanical loads and breakdown stresses by deformation, if necessary. The metallic phase of the cermet may be any suitable metal or metal alloy discussed above.

In the case of cermets, the powder includes at least one ceramic phase, which can provide the required amount of wear resistance and load-bearing characteristics for a given application. The ceramic phase can be formed from one or more constituents. Examples include various boride and diboride compounds, chromium disilicide, and the like. The selection of particular ceramic components will depend in part on the factors described previously. For example, if the end use of the thermal spray powder includes a turbine part subjected to a high degree of fretting, ceramic components that provide a relatively high degree of abrasion resistance and wear resistance may be desired.

Boride-containing ceramic compounds are used in some instances. As a non-limiting example, the ceramic phase comprises at least about 50% by weight boride compounds, and preferably at least about 80% boride compounds. General examples of the compounds include the transition metal diborides. (As used herein, “boride” is meant to embrace both borides and diborides, unless otherwise specified).

Some of the suitable compounds of this type are tungsten diboride, chromium boride, and molybdenum boride, as well as the refractory borides of Group IV (Ti, Zr, and Hf) and Group V (V, Nb, and Ta). It appears that these refractory borides exhibit a wide homogeneity range for boron, which permits greater boron proportions than those typically calculated by way of stoichiometry. The higher, relative boron content can in turn provide greater hardness and bond strength for the overall coating composition. Moreover, the Group IV and V borides also appear to exhibit a layered crystal structure, i.e., layers of metal atoms alternating with layers of boron atoms. The layered structure may be beneficial in some instances because of its affinity to certain solid lubricants (discussed below), which also exhibit a layered crystal structure. In some embodiments, titanium diboride (titanium boride) is employed as at least one of the ceramic constituents. In certain embodiments, the cermet comprises a material selected from the group consisting of tungsten carbide-cobalt, nickel aluminide, nickel chrome-chrome carbide, and tungsten carbide-cobalt chrome. In a particular embodiment, the matrix comprises tungsten carbide-cobalt or tungsten carbide-cobalt chrome.

In some optional, specific embodiments, the porous particles further comprise a secondary ceramic phase. The secondary phase can function to increase the overall toughness of the composition. The phase usually comprises at least one material selected from the group consisting of boron carbide, silicon carbide, titanium carbide, titanium nitride, diamond dust, and various nano-compounds, e.g., those having an average particle size of about 10-100 nanometers. Non-limiting examples of the nano-compounds are nano-alumina and other stable hard, oxide nano-particles formed from yttrium oxide, yttria-stabilized zirconia, hafnium oxide, silicon oxide (silicon dioxide), and mullite. Combinations of any of these materials are also possible. In some cases, suitable materials for the secondary phase are alumina, titanium nitride, diamond dust, and various combinations thereof. The secondary ceramic phase, if included, is usually present at a level, which is no greater than about 30-volume % of the entire ceramic phase.

The particles, which form the primary ceramic phase usually, have an average particle size of at least about 0.2 micron, and up to about 5 microns. In some specific embodiments, the particle size is in the range of about 0.2 micron to about 3 microns, and more specifically, in the range of about 1 micron to about 1.5 microns. Moreover, in some embodiments, the secondary ceramic phase has a finer particle size than that of the primary phase. The average particle size for the secondary ceramic phase is usually less than about 1 micron, and more specifically, no greater than about 100 nanometers.

The amount of the ceramic phase(s) will vary considerably, depending on many of the factors described herein, including, for example, the particular type of ceramics being used, as well as the desired hardness for the coating composition. In general, the ceramic phase (total) is present at a level in the range of about 30% by volume to about 95% by volume, based on the volume of the entire coating composition. In some specific embodiments, the level is in the range of about 40% by volume to about 80% by volume. In some especially specific embodiments, the level is in the range of about 50% by volume to about 70% by volume. The reduced, maximum amount in the last-mentioned range is sometimes advantageous for allowing the desired amount of lubricant component, discussed below.

It should be understood that many of the materials described herein are also described in U.S. patent application ______ (Attorney Docket 190563-1) of Uma Mannem et al. The Mannem et al Application is filed simultaneously with the present Application, and assigned to the same entity. Its contents are incorporated herein by reference).

Porous particles may be synthesized, or any of the commercially available particles may be used. Typically, the porous particles have an average particle size suitable for thermal spraying applications. In certain embodiments, the average particle size is in the range from about 20 micrometers to about 60 micrometers. In a particular embodiment, the average particle size is in a range from about 20 micrometers to about 50 micrometers.

In one embodiment, the porous particles have an average pore size in a range from about 1 micrometer to about 10 micrometers. In another embodiment, the porous particles have an average pore size in a range from about 1 micrometer to about 5 micrometers. Typically, the porous particles have a porosity in a range of from about 1% to about 90%. The porosity and pore dimensions of the porous particles, in part, depend on the amount and particle size of the solid lubricant to be infiltrated.

A mixture comprising a solvent and a plurality of solid lubricant particles are infiltrated into porous particles, in step 14. Typically, the solid lubricant particles comprise a material selected from the group consisting of a fluoride, a nitride, a sulfide, carbon, and boric acid. Examples of suitable solid lubricants include, but are not limited to, hexagonal boron nitride, graphite, molybdenum disulfide, tungsten sulfide; cryolite, calcium difluoride; barium difluoride (also referred to as “calcium fluoride” and “barium fluoride”, respectively); boric acid; carbon; and polytetrafluoroethylene. Combinations of any of these solid lubricants are also possible, e.g., eutectic mixtures of calcium difluoride and barium difluoride. The presence of the solid lubricant is very important for providing lubricity to the coating that may be obtained using the thermal spray powder, to decrease the friction between two surfaces.

The particular solid lubricant selected will depend on various factors. Wear and friction considerations for the part(s) on which the coating, obtained from the thermal spray powder, is being applied, are key considerations. Other important factors are the operating conditions i.e. temperature, moisture etc. of the part. The exposure temperature for the coating is important, since many lubricants can break down at very high temperatures. Compatibility of the solid lubricant with the materials, which are used for the metallic matrix and ceramic phase, is also an important consideration—during thermal spray deposition, and during use of the part at operating temperatures. In a particular embodiment, the solid lubricant comprises hexagonal boron nitride. In another particular embodiment, the solid lubricant comprises graphite.

The desired particle size of the lubricant will depend on the particular material being used. A particle size that is too small will decrease the beneficial effect of the lubricant, in reducing friction. Conversely, if the particle size of the lubricant is too large, tribological and mechanical properties may suffer. For example, the mechanical strength of the coating may decrease. Usually, the lubricant particles have a size, which permits them to be situated within the spacing that separates the primary hard particles in the metallic binder. In most embodiments, the average particle size of the solid lubricant particles is less than about 5 microns. In some embodiments it is less than about 1 micron. In some embodiments, the minimum particle size is at least about 0.2 micron. In some embodiments, the solid lubricant particles have an average particle size in the range from about 20 nanometers to about 5 micrometers.

Any suitable solvent may be used in the process. The solvent is desirably evaporated at a pre-selected temperature. The temperature should be low enough to prevent degradation of any of the components in the powder. However, the temperature should be high enough to evaporate the solvent. The solvent is desirably chemically inert, with low viscosity and good wetting ability. The solvent often comprises a material selected from the group consisting of water, acetone, and alcohol. In certain embodiments, the solvent comprises water.

The amount of lubricant which is utilized will also depend on many of the factors mentioned previously. As an example, an excessive amount of lubricant (or lubricant particles which are too large) may decrease the mechanical strength of the coating obtained from the thermal spray powder. Usually, the lubricant phase is present at a level in the range of about 5% by volume to about 80% by volume. A typical range for lubricant content (total solid lubricant content) is about 5% by volume to about 15% by volume.

The solution is infiltrated into the pores of the porous particles in step 14. Examples of suitable infiltration processes include, but are not limited to, injection, vacuum infiltration, and capillary filling of the solution. The exact process used depends on the solution material, cost, and various other criteria. In certain embodiments, the pore surfaces of the porous particles are treated with a suitable functional material in order to facilitate pore wetting and enhance infiltration of the solvent. For example, when the solvent is water, hydrophilic functional groups may be used to facilitate efficient infiltration. In such cases, the porous particles may be treated with desired functional groups prior to infiltration. In some embodiments, the functional groups may be attached to the selected regions of the porous particles by exposing the porous particles to solutions or vapors including the desired species.

In a particular embodiment, infiltration comprises vacuum infiltration. The use of a vacuum may help in the efficient infiltration of the solid lubricant within the pores of the porous particle. In certain embodiments, vacuum-infiltration comprises contacting the porous particle with the solution at a pressure of at least about −1.0 bar.

Vacuum infiltration may be followed by heating the infiltrated particles to remove the solvent from the infiltrated particles. (Alternatively, the infiltration and heating steps may be carried out simultaneously). The heating profile (temperature and duration) may be chosen based on various factors, e.g., the composition of the particles, the solvent used, and the like. Typically, heating comprises heating to a temperature in a range from about 20° C. to about 250° C.

In a particular embodiment, the method comprises: providing a powder which comprises porous particles of cobalt tungsten carbide; vacuum-infiltrating a mixture comprising water and hexagonal boron nitride into the porous particles; and heating the powder to a temperature sufficient to evaporate the solvent.

The embodiments disclosed herein are fundamentally different from the thermal spray powders and methods conventionally used. For instance, methods of making thermal spray powders have been described previously. Most of these methods are based on polymer binders. In some of the embodiments disclosed herein, the processed thermal spray particles are substantially free of any kind of binders or impurities. Many of the disclosed methods of the prior art involve mechanically attaching the lubricant particles to the metallic component, or encapsulating them in an autoclave. The process disclosed herein usually requires no mechanical blending or high temperature processes. The method enables a high loading of solid lubricant (as high as 80 volume percent) in the processed thermal spray powders. The thermal spray powder comprises the solid lubricant in an amount of at least about 5 volume percent. In one embodiment, the thermal spray powder comprises the solid lubricant in an amount in a range from about 5 volume percent to about 80 volume percent.

In many cases, solid lubricants such as hexagonal boron nitride (hBN)—used alone or even when mixed with a metal powder—cannot be sprayed effectively. The solid lubricant particles have low density, and are easily dispersed by the thermal spray gas flow process through the gun. The powder, processed by the method disclosed herein, is suitable for spraying.

The thermal spray powder may be deposited onto a substrate by any suitable thermal spray process. Selection of a particular technique will depend on various factors, such as the type and composition of the coating powder, feedstock particle size, and the end use contemplated for the part. Spray techniques are often effectively used here. Non-limiting examples include plasma deposition (e.g., ion plasma deposition, vacuum plasma spraying (VPS), low pressure plasma spray (LPPS), and plasma-enhanced chemical-vapor deposition (PECVD)); High-velocity-oxygen-fuel (HVOF) techniques; high-velocity air-fuel (HVAF) techniques; PVD, electron beam physical vapor deposition (EBPVD), CVD, APS, cold spraying, and laser ablation.

Thermal spray techniques are of special interest for some embodiments. Examples listed above include VPS, LPPS, HVOF, HVAF, APS, and cold-spraying. In many instances, HVOF or HVAF is the preferred technique. Those skilled in the art are familiar with the operating details and considerations for each of these techniques. Moreover, various combinations of any of these deposition techniques could be employed.

A method of forming a wear-resistant coating on a substrate is disclosed. The method comprises: providing a thermal spray powder; heating the thermal spray powder; and accelerating the thermal spray powder from a thermal spray gun onto the substrate, to form a deposit. The thermal spray powder is formed by the process of: providing a powder comprising a plurality of porous particles; vacuum-infiltrating a mixture comprising a solvent and a plurality of solid lubricant particles into the porous particles; and heat-treating the powder to a temperature sufficient to evaporate the solvent, as discussed in detail above.

As discussed above, the porous particles comprise a material selected from the group consisting of a metal, a metal alloy, a cermet, and various combinations thereof. The solid lubricant particles usually comprise at least one material selected from the group consisting of hexagonal boron nitride, graphite, molybdenum disulfide, tungsten sulfide; calcium difluoride; calcium-barium difluoride, polytetrafluoroethylene, carbon, and boric acid.

One embodiment of the invention is a wear-resistant coating formed by the method described above. The wear-resistant coating is particularly useful as a coating for engine components. In a particular embodiment, the engine component comprises a turbomachine component.

A variety of substrates could be covered or partially covered by the coating compositions described herein. Many of them are components for turbines, e.g., land-based gas turbines, steam turbines, marine turbines, and aeronautical turbines. Specific, non-limiting examples of the turbine components are buckets, nozzles, blades, rotors, vanes, stators, shrouds, combustors, and blisks. Non-turbine applications are also possible. Examples include components of other articles used under conditions of high temperature and/or high-wear environments. One such article is an internal combustion engine. As an example, the coating could be used on bearing surfaces and flanks of piston rings in such engines, con-rods & pins that are specifically subject to fretting wear. (The substrate is usually formed of a metal material. As used herein, “metal” is meant to also include materials which are primarily formed of metal or metal alloys, but which may also include some non-metallic constituents, components or attachments, e.g., those made of ceramics, plastics, and the like).

As alluded to previously, the wear-resistant coatings described herein are particularly useful for deposition on a metal alloy which includes a contact surface which is shaped or positioned to cooperate with the contact surface of an abutting member. In such an instance, the coating (which could also be applied to the abutting member) substantially prevents fretting wear between the contact surfaces. It is believed that the coatings are especially suitable for supporting high-contact stresses between such surfaces, e.g., stresses which may exceed about 30,000 psi. Moreover, the coatings may be especially useful when employed under oxidizing conditions at elevated temperatures, e.g., above about 650° F. (343° C.). In contrast, prior art wear coatings, like those based on molybdenum sulfide and an organic binder, may oxidize and lose their effectiveness under such conditions.

The thickness of the wear-resistant coating will depend on many of the other factors discussed previously, e.g., composition of the coating and article, the end use of the article, and the like. Usually, the coating will have a thickness of about 50 microns to about 1,000 microns. In some specific embodiments (e.g., in many of the gas turbine applications), the thickness will be in the range of about 100 microns to about 400 microns.

The following example serves to illustrate the features and advantages offered by the embodiments of the present invention, and is not intended to limit the invention thereto.

### EXAMPLE 1

### Tungsten Carbide Based Powders Infiltrated with Hexagonal Boron Nitride Particles

200 mL of WC/Co powder was mixed with 200 mL of boron nitride in suspension, and 20 mL of hot water. Three types of Nanomyte® powders were mixed with boron nitride in separate jars. Powder A: WC/8Co4Cr, Powder B: WC/12Co, and Powder C: WC/9Co. The mixture was put in vacuum furnace at a temperature of 100° C. at −30″ Hg (−1.0 bar). The mixture was left overnight. The resulting material was in a dry and hard (non-powder) form. The powder was mechanically crushed to return it to powder form. (Nanomyte® is a product of NEI. Liquid boron nitride is a product of Montreal Carbides.) The powders were thermally sprayed onto a substrate, by feeding the powder into a “standard” HVOF (High Velocity Oxygen Fuel, with the fuel being Hydrogen) process. The HVOF process we used was the Sulzer Metco Diamond Jet system. Microscopy and X-ray photoelectron microscopy (XPS) measurements were performed on a Kratos Axis Ultra DLD XPS system, using a monochromatic Al Kα radiation (1486.6 eV) at 225 W. XPS probing depth was typically 0.5-5 nm. The analysis area employed for this study was about 700×300 micrometers. To minimize the charging effects on the sample, a low energy electron gun was used for charge neutralization. The sample was rinsed using isopropyl alcohol, prior to the XPS analysis. The surface was analyzed as received and after a brief sputtering. Sputtering was performed using 4 keV Ar+ ion beams rastering a 2×2 mm² area. The sputter rate for an SiO₂ standard at this condition is about 70 Å/min. Survey scans were performed to obtain the overall compositions, which shows 16 weight % of hBN within the scanned region of the coating. The dispersion of hBN particles was uniform throughout the scanned region.

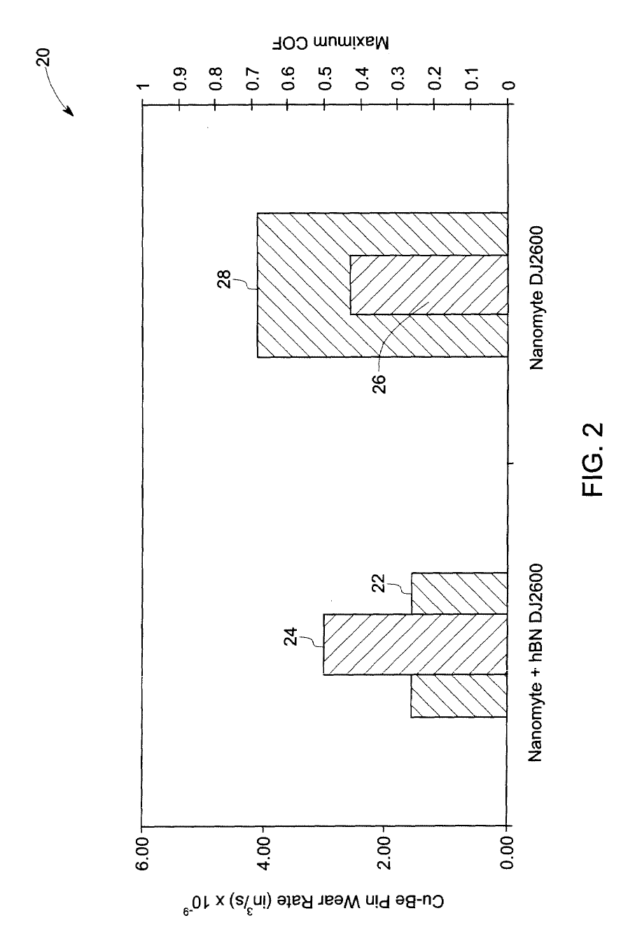

FIG. 2 shows the wear resistivity data measured on the coatings prepared using the procedure described above. A pin-on-disc test rig was used to measure sliding friction and wear properties of a copper based alloy, which in this case was a stationary pin against 2 coatings of Nanomyte® without and with 40 vol % of hBN added to the initial powder. Pin-on-disc test involves a rotating disc (including the coating) and a stationary pin (copper based alloy), with a normal load applied to the pin. The pin had a 2 inches radius, so the Hertzian Contact pressures at the start of the tests are different to those at the end because the pin surface area changed due to wear.

The plot 20 shows the wear of the copper pin and the respective friction coefficients. Clearly, wear of the pin against the hBN-containing coating (bar 22) is ˜2.5 times less than the same coating without hBN (bar 28). The friction coefficient value does not seem to be affected for the two samples (bars 24 and 26). In this case, because copper based alloy is a softer material than the coating material, any measurable wear is only on the copper based alloy.

It will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent articles, and other references mentioned above are incorporated herein by reference.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of making a thermal spray powder, the method comprising:
providing a powder comprising a plurality of porous particles;
infiltrating a mixture comprising a solvent and a plurality of solid lubricant particles into the porous particles, and
heat-treating the powder to a temperature sufficient to evaporate the solvent.

2. The method of claim 1, wherein the porous particles comprise a material selected from the group consisting of a metal, a metal alloy, a ceramic, a cermet, and combinations thereof.

3. The method of claim 2, wherein the metal comprises at least one metal selected from the group consisting of titanium, nickel, iron, cobalt, chromium, aluminum, and yttrium.

4. The method of claim 2, wherein the ceramic comprises a material selected from the group consisting of aluminum oxide, chromium oxide, chromium-carbide, tantalum carbide, titanium diboride, titanium oxide, tungsten-carbide, and titanium carbide.

5. The method of claim 2, wherein the cermet comprises a material selected from the group consisting of tungsten carbide-cobalt, nickel aluminide, nickel chrome-chrome carbide, and tungsten carbide-cobalt chrome.

6. The method of claim 5, wherein the cermet comprises a material selected from the group consisting of tungsten carbide-cobalt and tungsten carbide-cobalt chrome.

7. The method of claim 1, wherein the porous particles have an average pore size in the range from about 1 micrometer to about 10 micrometers.

8. The method of claim 7, wherein the porous particles have an average pore size in the range from about 1 micrometer to about 5 micrometers.

9. The method of claim 1, wherein the porous particles have a porosity in a range of from about 1% to about 90%.

10. The method of claim 1, wherein the solid lubricant particles comprise at least one material selected from the group consisting of a fluoride, a nitride, a sulfide, carbon, and boric acid.

11. The method of claim 10, wherein the solid lubricant particles comprise at least one material selected from the group consisting of hexagonal boron nitride, graphite, molybdenum disulfide, tungsten sulfide, calcium difluoride, calcium-barium difluoride, polytetrafluoroethylene, carbon, and boric acid.

12. The method of claim 10, wherein the solid lubricant particles comprise hexagonal boron nitride.

13. The method of claim 1, wherein the solid lubricant particles have an average particle size less than about 5 micrometers.

14. The method of claim 13, wherein the solid lubricant particles have an average particle size in the range from about 20 nanometers to about 3 micrometers.

15. The method of claim 1, wherein the solvent comprises a material selected from the group consisting of water, acetone, and alcohol.

16. The method of claim 15, wherein the solvent comprises water.

17. The method of claim 1, wherein infiltration comprises at least one process selected from the group consisting of injection, vacuum infiltration, and capillary filling of the solution.

18. The method of claim 17, wherein infiltration comprises vacuum-infiltration.

19. The method of claim 18, wherein the vacuum infiltration comprises contacting the porous particle with the solution at a pressure of at least about −1.0 bar.

20. The method of claim 1, wherein heat-treating comprises heating to a temperature in a range from about 20° C. to about 250° C.

21. The method of claim 1, wherein the thermal spray powder comprises the solid lubricant particles in an amount of at least about 5 volume percent.

22. The method of claim 1, wherein the thermal spray powder comprises the solid lubricant in an amount in a range of about 5 volume percent to about 80 volume percent.

23. A method of making a thermal spray powder, the method comprising:
providing a powder which comprises porous particles of cobalt tungsten carbide;
vacuum-infiltrating a mixture comprising water and hexagonal boron nitride into the porous particles, and
heat-treating the powder to a temperature sufficient to evaporate the solvent.

24. A method of forming a wear-resistant coating on a substrate, the method comprising:
providing a thermal spray powder;
heating the thermal spray powder; and
accelerating the thermal spray powder from a thermal spray gun onto the substrate, to form a deposit, wherein the thermal spray powder is formed by the process of:
providing a powder comprising a plurality of porous particles;
infiltrating a mixture comprising a solvent and a plurality of solid lubricant particles into the porous particles, and
heat-treating the powder to a temperature sufficient to evaporate the solvent.

25. The method of claim 24, wherein the porous particles comprise a material selected from the group consisting of a metal, a metal alloy, a ceramic, a cermet, and combinations thereof.

26. The method of claim 24, wherein the solid lubricant particles comprise at least one material selected from the group consisting of hexagonal boron nitride, graphite, molybdenum disulfide, tungsten sulfide, calcium difluoride, calcium-barium difluoride, polytetrafluoroethylene, carbon, and boric acid.

27. A wear-resistant coating formed by the method of claim 24.

28. A turbomachine containing at least one surface covered by the wear-resistant coating of claim 27.
